(19) United States
(12) Patent Application Publication
(10) Pub. No.: US 2016/0219356 A1
(43) Pub. Date: Jul. 28, 2016

(54) EARPHONE ASSEMBLY

(71) Applicant: HON HAI PRECISION INDUSTRY CO., LTD., New Taipei (TW)

(72) Inventor: CHIA-CHIEH CHENG, New Taipei (TW)

(21) Appl. No.: 14/797,689

(22) Filed: Jul. 13, 2015

(30) Foreign Application Priority Data
Jan. 26, 2015 (TW) 104102462

(51) Int. Cl. H04R 1/10

(52) U.S. Cl. CPC H04R 1/1025

(57) ABSTRACT

An earphone assembly can include an earphone and a container. The container can include a housing having a receiving slot and a conductor coupled to the hosing. The conductor can include an inserting portion received in the receiving slot and a connecting portion positioned in the housing. The inserting portion can be configured to protrude through the housing. The connecting portion can be configured to be coupled to the inserting portion. The earphone can be configured to be wirelessly coupled to an electronic device. The earphone can include a conductive portion corresponding to the connecting potion. The receiving slot can be configured to receive the earphone, whereby the connecting portion can be capable of electrically contact the conductive portion. The inserting portion can be configured to be coupled to the electronic device, so that the earphone can be configured to be charged by the electronic device.

### FIELD

The subject matter herein generally relates to earphone assemblies.

### BACKGROUND

A headphone can be used when a user is listening to music or making a phone call. Headphones typically include two wires, one for each of the speakers. These wires can be configured such that they are joined together until a predetermined length.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a cross sectional view of an embodiment of an earphone assembly attaching to an electronic device, the earphone assembly including a container and an earphone, the earphone coupled to the container.

FIG. 2 is a cross sectional view of the earphone assembly of FIG. 1, the earphone departed from the container.

FIG. 3 is a block diagram of the earphone assembly and the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to an earphone assembly.

An earphone assembly can include an earphone and a container configured to receive the earphone. The container can include a housing having a receiving slot, and a conductor coupled to the housing. The conductor can include an inserting portion received in the receiving slot and a connecting portion positioned in the housing. The inserting portion can be configured to protrude through a side wall of the housing, so that the inserting portion can be exposed at an outside of the housing. The connecting portion can be configured to be coupled to the inserting portion. The earphone can be configured to be wirelessly coupled to an electronic device. The earphone can include a conductive portion corresponding to the connecting potion. The receiving slot can be configured to receive the earphone, such that the connecting portion can be configured to electrically contact the conductive portion. The inserting portion can be configured to be coupled to the electronic device, wherebythe earphone can be configured to be charged by the electronic device.

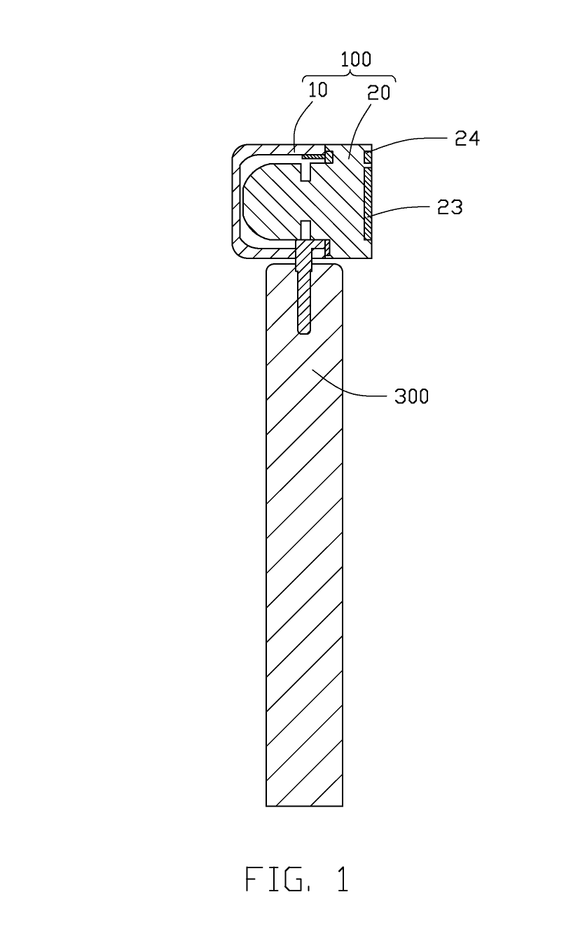

Referring the FIGS. 1, the earphone assembly 100 can include a container 10 and an earphone 20. The container 10 can be detachably coupled to an electronic device 300 and electrically coupled to the electronic device 300. In some instances, the electronic device 300 can be a music player, a cell phone, a smart phone, a tablet personal computer, a desktop computer, a laptop computer, or any other electronic devices. The earphone 20 can be received in the container 10 and can be electrically coupled to the container 10, whereby the earphone 20 can be charged while conducting with the container 10. The earphone 20 can be configured to be wirelessly coupled to the electronic device 100 and can be configured to generate audio signal while receiving the audio signal produced by the electronic device 300.

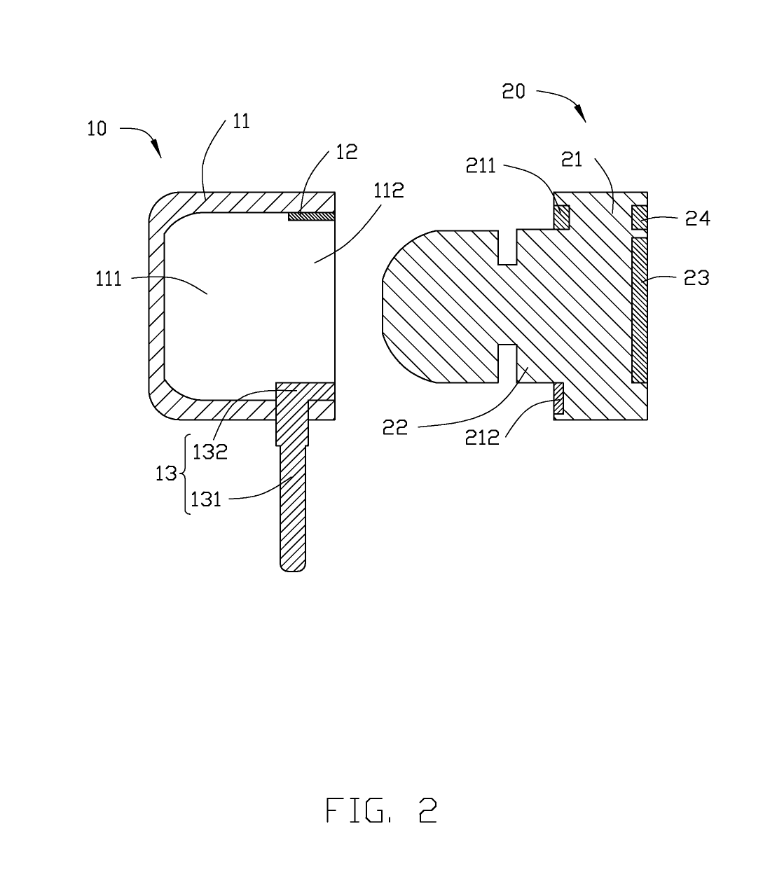

Referring the FIGS. 2, the container 10 can include a housing 11, a first magnet portion 12, and a conductor 13.

The housing 11 can define a receiving slot 111 and an opening 112. The opening 112 can be defined at a side of the housing 11. The receiving slot 11 can be defined in the housing 11 and can communicate with the opening 112.

The first magnet portion 12 can be positioned in the receiving slot 111 and mounted to an inside wall of the receiving slot 111 adjacent to the opening 112.

The conductor 13 can be positioned in the receiving slot 111, and mounted to the inside wall of the receiving slot 111, oppositely to the first magnet portion 12. In the illustrated embodiment, the conductor 13 can be substantially L shaped. The conductor 13 can include an inserting portion 131 and a connecting portion 132 coupled to the inserting portion 131.

The inserting portion 131 can include a first end 1311 and a second end (not labeled) opposite to the first end 1311. In some instances, the inserting potion 131 can be an audio plug. The first end 1311 is positioned at a tail end of the inserting portion 131, away from the connecting portion 132. The first end 1311 can be inserted through the housing 11 and exposed at the outside of the housing 11. The first end 1311 can be configured to insert into the electronic device 300. In some instances, the electronic device 300 can have an audio out jack, and the first end 1311 can be inserted into the audio out jack. The second end can be fixed to the housing 12. The connecting portion 132 can be positioned in the receiving slot 111 coupled to the second end, and mounted a side wall of the receiving slot 111. An end of the connecting portion 132 can extend though the opening 112, towards the outside of the housing 11.

The earphone 20 can include a main body 21, and a speaker 22 coupled to the main body 21. The main body 21 can provide a second magnet portion 211 and a conductive portion 212 at an end thereof adjacent to the speaker 22. The second magnet portion 211 can correspond to the first magnet portion 12. The conductive portion 212 can correspond to the connecting portion 132.

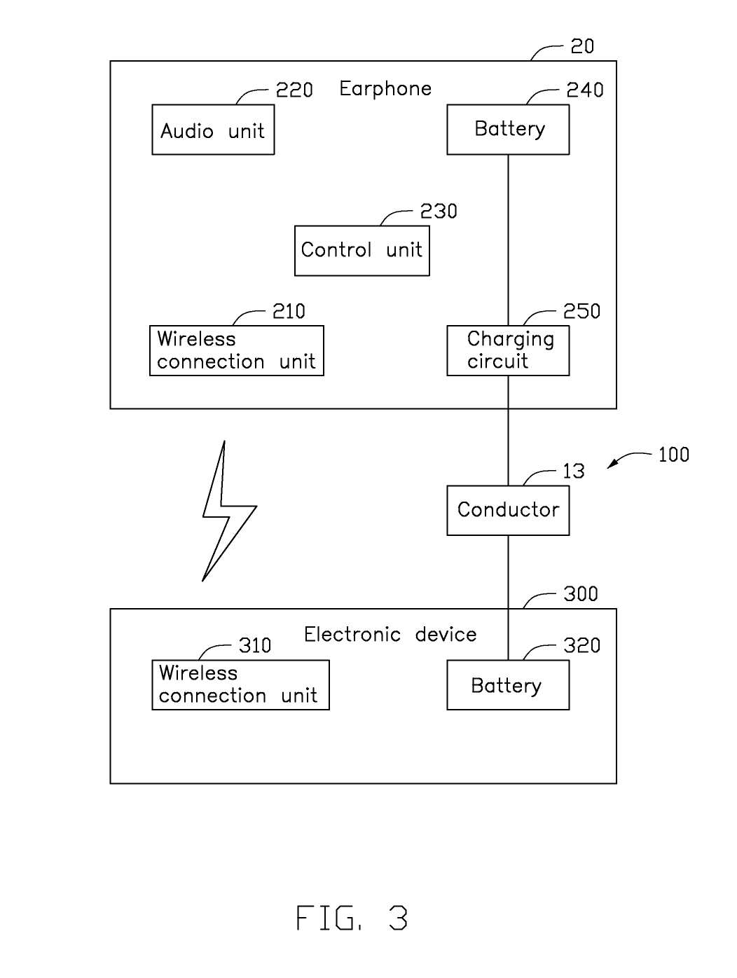

FIG. 3 illustrates a block diagram of the earphone assembly 100 and the electronic device 300. The earphone 20 can provide a wireless connection unit 210, an audio unit 220, a control unit 230, a battery 240, and a charging circuit 250. The control unit 230 can be electrically coupled to the wireless connection unit 210, the audio unit 220, and the battery 240. The battery 240 can be further coupled to the charging unit 250. The charging unit 250 can be further electrically coupled to the conductor 13.

In an alternative embodiment, the electronic device 300 can provide a wireless connection unit 310 and a battery 320 inside thereof When the earphone 20 is charged via the electronic device 300, the speaker 22 can be received in the receiving slot 111, and the inserting portion 131 can be inserted into the audio out jack of the electronic device 300, whereby the charging circuit 250 can be electrically connected to the battery 320 of the electronic device 300, via the conductor 13. So that the battery 320 of the electronic device 300 can charge the battery 240 of the earphone 20. Furthermore, the second magnet portion 211 can be contacted with the first magnet portion 12 when the speaker 22 received in the receiving slot 111, such that the earphone 20 can be firmly coupled to the container 10.

In operation, the wireless connection unit 210 of the earphone assembly 100 can be activated, and the wireless connection unit 310 can be activated. The earphone assembly 100 can be electrically coupled with the electronic device 300 when the wireless connection unit 210 matches the wireless connection unit 310. The electronic device 300 can transfer an audio signal to the earphone 20, via the wireless connection unit 320. The wireless connection unit 210 of the earphone 20 can received the audio signal. The control unit 230 can control the audio unit 220 to emit audio signal according to the audio signal received by the wireless connection unit 210.

In an alternative embodiment, the inserting portion 131 can be another plug except an audio plug. For example, the inserting portion 131 can be a charging plug configured to be detachably coupled to a data interface of the electronic device 300.

The earphone 20 can be fixedly or removably coupled to the container 10 when the second magnet portion 211 is attached to the first magnet portion 12. In an alternative embodiment, the earphone 20 can be firmly coupled to the container 10 via a latching structure.

In an alternative embodiment, the earphone 20 can include a switch 23 thereon. The switch 23 can be positioned on any portion of the earphone 20, such as, but not limited to, the main body 21, the speaker 22, or any other portions of the earphone 20. In some instances, the switch 23 can be a button switch, and can be configured to turn on/off the earphone 20 when pushed by a user. In some instances, the switch 23 can be a knob switch, a toggle switch, or any other switches.

In an alternative embodiment, the earphone 20 can further provide an indicator 24 thereon. The indicator 24 can be positioned on any portion of the earphone 20, such as, but not limit to, the main body 21, the speaker 22, or any other portions of the earphone 20. The indicator 24 can be configured to indicate a switching status of the earphone 20. In some instances, the indicator 24 can be an indicator lamp whereby the indicator 24 can be configured to indicate a switching status of the earphone 20 with blinking light.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure, as defined by the appended claims.

What is claimed is:

1. An earphone assembly comprising:
a container comprising:
a housing having a receiving slot; and
a conductor coupled to the housing and comprising:
an inserting portion received in the receiving slot and protruding through a side wall of the housing, so that the inserting portion is exposed at an outside of the housing, and
a connecting portion positioned in the housing and coupled to the inserting portion; and
an earphone configured to be wirelessly coupled to an electronic device, the earphone comprising a conductive portion corresponding to the connecting potion;
wherein the receiving slot is configured to receive the earphone, such that the connecting portion is configured to electrically contact the conductive portion, and the inserting portion is configured to be coupled to the electronic device, whereby the earphone is configured to be charged by the electronic device.

2. The earphone assembly of claim 1, wherein, the housing defines an opening communicating with the receiving slot; the container further comprises a first magnet portion positioned in the housing and adjacent to the opening; the earphone further comprises a second magnet portion configured to contact with the first magnet portion.

3. The earphone assembly of claim 2, wherein, the earphone further comprises a main body and a speaker coupled to the main body; the speaker is configured to be received in the receiving slot, the conductive portion and the second magnet portion are positioned at a side of the main body adjacent to the speaker.

4. The earphone assembly of claim 1, wherein, the inserting portion is an audio plug configured to insert into an audio out jack of the electronic device, such that the earphone is configured to be charged by the electronic device.

5. The earphone assembly of claim 1, wherein, the inserting portion is a charging plug configured to insert into a data interface of the electronic device, such that the earphone is configured to be charged by the electronic device.

6. The earphone assembly of claim 1, wherein, the earphone further comprises a switch configured to turn on or turn off the earphone.

7. The earphone assembly of claim 6, wherein, the earphone further comprises an indicator configured to indicate a switching status of the earphone.

8. The earphone assembly of claim 1, wherein, the earphone further comprise a battery and a charging circuit; the conductor is configured to insert into the electronic device when the earphone is received in the housing, thereby the charging circuit is electrically coupled to a battery of the electronic device.

9. The earphone assembly of claim 8, wherein, the earphone further comprises a wireless connection unit configured to be wirelessly coupled to the electronic device.

10. The earphone assembly of claim 8, wherein, the earphone further comprises a an audio unit, and a control unit; the control unit is configured to control the audio unit to emit audio signal transferred by the electronic device.

11. An earphone assembly comprising:
an earphone configured to be wirelessly coupled to an electronic device; the earphone comprising:
a conductive portion;
a container comprising:
a housing; and
a conductor coupled to the housing and comprising:
an inserting portion received in the housing, and protruding through a side wall of the housing; wherein, the inserting portion is configured to be coupled to the electronic device, whereby the earphone is configured to be charged by the electronic device, and
a connecting portion positioned in the housing and coupled to the inserting portion, the connecting portion corresponding to the conductive portion;
wherein, the earphone is configured to be positioned in the housing, whereby the connecting portion is configured to electrically contact the conductive portion.

12. The earphone assembly of claim 11, wherein, the housing defines an opening communicating with the receiving slot; the container further comprises a first magnet portion positioned in the housing and adjacent to the opening; the earphone further comprises a second magnet portion configured to contact with the first magnet portion.

13. The earphone assembly of claim 12, wherein, the earphone further comprises a main body and a speaker coupled to the main body; the speaker is configured to be received in the housing, the conductive portion and the second magnet portion are positioned at a side of the main body adjacent to the speaker.

14. The earphone assembly of claim 11, wherein, the inserting portion is an audio plug configured to insert into an audio out jack of the electronic device, such that the earphone is configured to be charged by the electronic device.

15. The earphone assembly of claim 11, wherein, the inserting portion is a charging plug configured to insert into a data interface of the electronic device, such that the earphone is configured to be charged by the electronic device.

16. The earphone assembly of claim 11, wherein, the earphone further comprises a switch configured to turn on or turn off the earphone.

17. The earphone assembly of claim 16, wherein, the earphone further comprises an indicator configured to indicate a switching status of the earphone.

18. The earphone assembly of claim 11, wherein, the earphone further comprises a battery and a charging circuit; the conductor is configured to insert into the electronic device when the earphone is received in the housing, thereby the charging circuit is electrically coupled to a battery of the electronic device.

19. The earphone assembly of claim 18, wherein, the earphone further comprises a wireless connection unit, an audio unit, and a control unit; the wireless connection unit is configured to be wirelessly coupled to the electronic device; the control unit is configured to control the audio unit to emit audio signal transferred by the electronic device.

20. An earphone assembly comprising:
an earphone configured to be wirelessly coupled to an electronic device; the earphone comprising:
a conductive portion;
a container comprising:
a housing; and
a conductor coupled to the housing and comprising:
an inserting portion received in the housing; and
a connecting portion coupled to the inserting portion, and corresponding to the conductive portion;
wherein, the earphone is configured to be positioned in the housing, whereby the connecting portion is configured to electrically contact the conductive portion; the inserting portion is configured to be coupled to the electronic device, whereby the earphone is configured to be charged by the electronic device.
